(19) United States
(12) Patent Application Publication
(10) Pub. No.: US 2026/0331894 A1
(43) Pub. Date: Oct. 22, 2026

(54) WIRE HARNESS ROUTING APPARATUS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Ryohei KAKAMI, Osaka (JP); Satoshi YAMAMOTO, Osaka (JP)

(21) Appl. No.: 19/119,408

(22) PCT Filed: Oct. 2, 2023
(86) PCT No.: PCT/JP2023/035901

§ 371 Date: Apr. 9, 2025

(30) Foreign Application Priority Data
Oct. 19, 2022 (JP) 2022-167303

(51) Int. Cl. H02G 11/02; B60R 16/02; B60R 16/027

(52) U.S. Cl. CPC H02G 11/02; B60R 16/0215; B60R 16/027

(57) ABSTRACT

A wire harness routing apparatus includes a guide portion, a slider, and a wire harness. The guide portion includes a first rail member and a second rail member that face each other and spacers that position the first rail member and the second rail member to produce an accommodating space between the first rail member and the second rail member. The slider is supported by the guide portion so as to be capable of reciprocal movement between a first position and a second position. The wire harness includes a slider fixed portion that is fixed to the slider and moves in conjunction with movement of the slider, and a moving section that is continuous with the slider fixed portion and moves within the accommodating space as the slider moves.

### TECHNICAL FIELD

The present disclosure relates to a wire harness routing apparatus.

### BACKGROUND

Patent Document 1 discloses an electric wire routing apparatus that routes electric wires between the floor of an automobile and a seat that is capable of sliding relative to the floor. The electric wires are attached to a slider that slides in conjunction with the seat and are guided to the seat. The slider is slidably attached to a moving portion, which is tubular and parallel to a support rail.

### PRIOR ART DOCUMENT

### Patent Document

Patent Document 1: JP 2010-193599 A

### SUMMARY OF THE INVENTION

### Problems to be Solved

For the electric wire routing apparatus described in Patent Document 1, the size of the space that accommodates the electric wires in the tubular moving portion is set in advance. This means that it can be difficult to use a single type of moving portion for a plurality of types of wire harness that have different numbers of circuits.

It is an object of the present invention to provide a wire harness routing apparatus that can be easily applied to a plurality of types of wire harness that have respectively different numbers of circuits.

### Means to Solve the Problem

A wire harness routing apparatus according to an aspect of the present disclosure includes: a guide portion including a first rail member and a second rail member that face each other and spacers that position the first rail member and the second rail member so that an accommodating space is produced between the first rail member and the second rail member; a slider supported by the guide portion so as to be capable of reciprocally moving between a first position and a second position; and a wire harness including a slider fixed portion that is fixed to the slider and moves in conjunction with movement of the slider and a moving section that is continuous with the slider fixed portion and moves inside the accommodating space as the slider moves.

### Effect of the Invention

According to the present disclosure, there is provided a wire harness routing apparatus that can be easily applied to a plurality of types of wire harness that have respectively different numbers of circuits.

### BRIEF DESCRIPTION OF THE DRAWINGS

FIG. 1 is a perspective view depicting a wire harness routing apparatus according to a first embodiment.

FIG. 2 is a plan view depicting the wire harness routing apparatus in a state where a slider is at a first position.

FIG. 3 is a plan view depicting the wire harness routing apparatus in a state where the slider is at a second position.

FIG. 4 is a cross-sectional view depicting the wire harness routing apparatus.

FIG. 5 is an exploded view depicting the wire harness routing apparatus.

FIG. 6 is a perspective view depicting a first rail member.

FIG. 7 is a perspective view depicting a wire harness.

### DETAILED DESCRIPTION TO EXECUTE THE INVENTION

### Outline of Embodiments of the Present Disclosure

Embodiments of the present disclosure will first be listed and described.

A wire harness routing apparatus according to the present disclosure is as described below.

(1) A wire harness routing apparatus including: a guide portion including a first rail member and a second rail member that face each other and spacers that position the first rail member and the second rail member so that an accommodating space is produced between the first rail member and the second rail member; a slider supported by the guide portion so as to be capable of reciprocally moving between a first position and a second position; and a wire harness including a slider fixed portion that is fixed to the slider and moves in conjunction with movement of the slider and a moving section that is continuous with the slider fixed portion and moves inside the accommodating space as the slider moves.

With the wire harness routing device according to (1), the size of the accommodating space can be changed by changing the spacers. By doing so, a single pair of a first rail member and a second rail member can easily accommodate different numbers of circuits in the wire harness. Changing the spacers is easier than changing the first rail member and the second rail member. By doing so, the wire harness routing apparatus can be easily applied to a plurality of types of wire harness that have respectively different numbers of circuits.

(2) In the wire harness routing apparatus according to (1), the first rail member may include a first bottom portion and at least one first protruding wall portion that protrudes from the first bottom portion toward the second rail member, the second rail member may include a second bottom portion that faces the first bottom portion and at least one second protruding wall portion that protrudes from the second bottom portion toward the first rail member, the slider may be supported by the first protruding wall portion or the second protruding wall portion, and the accommodating space may be a space surrounded by the first bottom portion, the at least one first protruding wall portion, the second bottom portion, and the at least one second protruding wall portion. By doing so, it is possible for the slider to be supported by a protruding wall portion and for both sides of the moving section to be covered by the protruding wall portions. This makes it easier for the slider and the wire harness to move smoothly relative to the guide portion.

(3) In the wire harness routing apparatus according to (2), the first rail member may include two first protruding wall portions, the second rail member may include two second protruding wall portions that face the two first protruding wall portions, the accommodating space may be a space surrounded by the first bottom portion, the two first protruding wall portions, the second bottom portion, and the two second protruding wall portions, the slider may include a first end portion located in the accommodating space and a second end portion located outside the guide portion, and a part of the slider between the first end portion and the second end portion may extend between a pair of one first protruding wall portion and one second protruding wall portion. By doing so, it is possible for the protruding wall portions to cover both sides of the slider and the moving section on both the first bottom side and the second bottom side. This makes it easier for the slider and the wire harness to move smoothly relative to the guide portion.

(4) In the wire harness routing apparatus according to (3), the two first protruding wall portions may be a first long protruding wall portion and a first short protruding wall portion that have different protruding dimensions from the first bottom portion, the two second protruding wall portions may be a second long protruding wall portion and a second short protruding wall portion that have different protruding dimensions from the second bottom portion, the first long protruding wall portion and the second short protruding wall portion may face each other and the first short protruding wall portion and the second long protruding wall portion may face each other, the second rail member may be disposed so as to be positioned vertically below the first rail member, and the slider may extend from the first end portion toward the second end portion while passing between the first short protruding wall portion and the second long protruding wall portion. The gap between a pair of a first protruding wall and a second protruding wall is an opening through which the slider passes. Even in this case, since the protruding portion below the opening is the second long protruding wall, intrusion of foreign matter located outside the guide portion into the accommodating space is less likely.

(5) In the wire harness routing apparatus according to any one of (1) to (4), the first rail member and the second rail member may have the same shape. By doing so, it is possible to produce the first rail member and the second rail member by preparing a plurality of parts of a single type.

(6) In the wire harness routing apparatus according to (5), the first rail member may be shaped so that a first cross-sectional shape is continuous in a length direction, the second rail member may be shaped so that a second cross-sectional shape is continuous in a length direction, and the first cross-sectional shape and the second cross-sectional shape may be the same. This makes it possible to cut out predetermined lengths from an elongated extrusion-molded product as the first rail member and the second rail member.

(7) In the wire harness routing apparatus according to any one of (1) to (6), stoppers may be provided on the spacers at end portions in a direction of movement of the slider. This eliminates the need to provide stoppers at separate positions from the spacers.

(8) In the wire harness routing apparatus according to any one of (1) to (7), the wire harness may include a plurality of electric wires and a protective member that keeps the plurality of electric wires in a flattened arrangement in the moving section, and the spacers may separate the first rail member and the second rail member in a length direction of a cross section of the flattened wire harness. By doing so, when the number of circuits has increased, the moving section will become larger in the length direction of the flattened cross section. This suppresses an increase in the thickness of the moving section even when the number of circuits of the wire harness increases.

(9) In the wire harness routing apparatus according to (8), the moving section may be a section whose length accommodated in the accommodating space changes in keeping with a position of the slider that moves reciprocally between the first position and the second position, a section out of the moving section that is accommodated in the accommodating space when the slider is at the first position and is positioned outside the guide portion when the slider is at the second position may be defined as an excess length section, and the wire harness routing apparatus may further include an excess length accommodating portion that accommodates, when the slider is at the second position, the excess length section positioned outside the guide portion in a spiral shape that has an axis along the length direction as a center axis. When the number of circuits has increased, the excess length section also becomes larger in the length direction in the flattened cross section. By accommodating the excess length section in the excess length accommodating section in a spiral shape with an axis along the longitudinal direction in the cross section of the flattened wire harness as the center axis, when the number of circuits of the wire harness has increased, an increase in the diameter of the excess length section accommodated in a spiral shape is suppressed.

### Detailed Description of Embodiments of the Present Disclosure

Specific embodiments of a wire harness routing apparatus according to the present disclosure will now be described with reference to the attached drawings. Note that the present disclosure is not limited to the embodiments described here but indicated by the claims and is intended to include all changes within the meaning and scope of the claims and their equivalents.

### First Embodiment

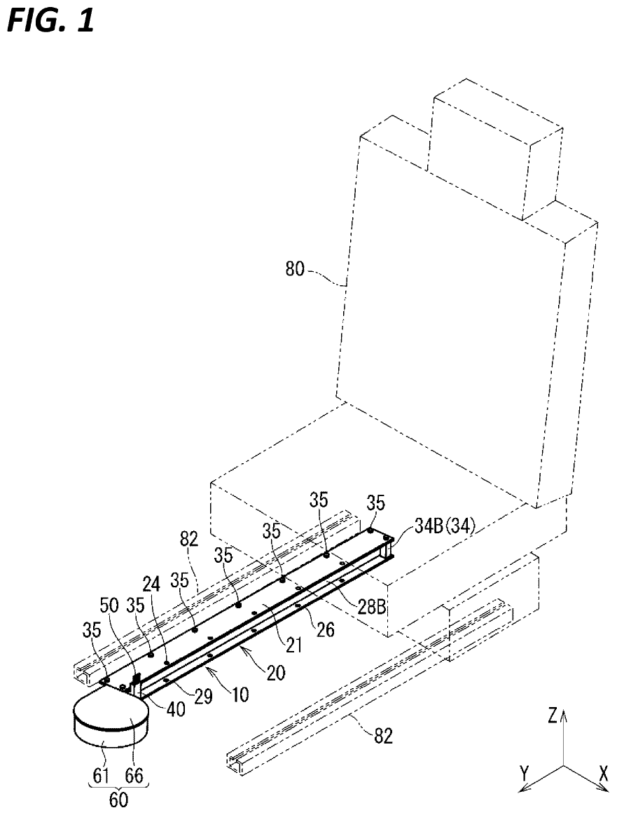

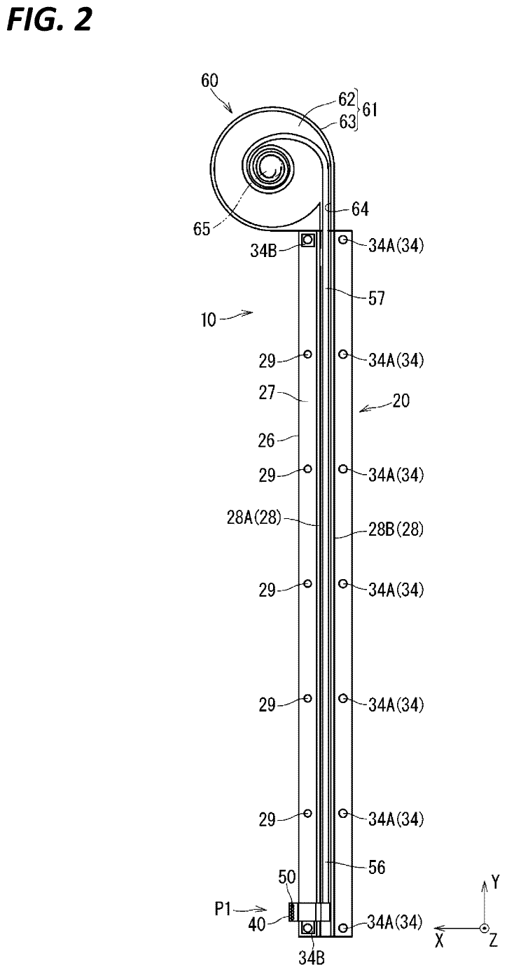

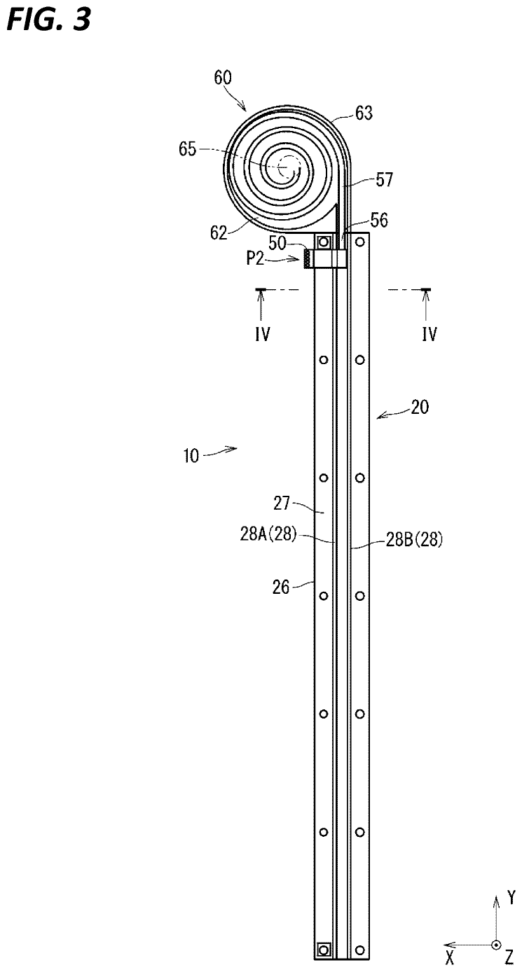

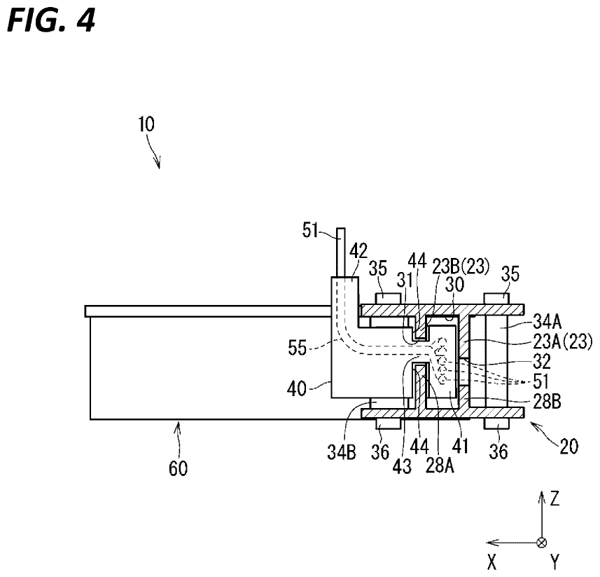

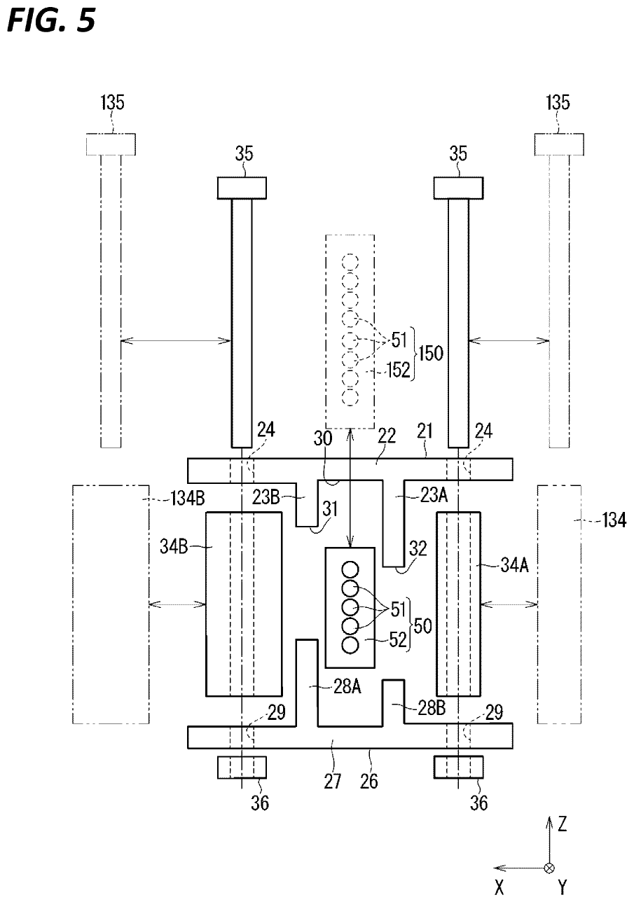

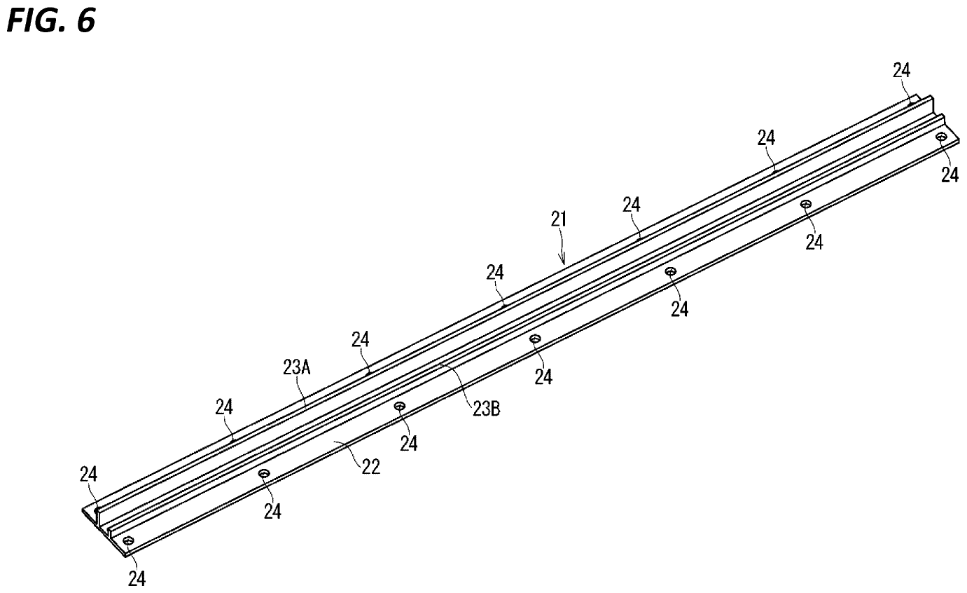

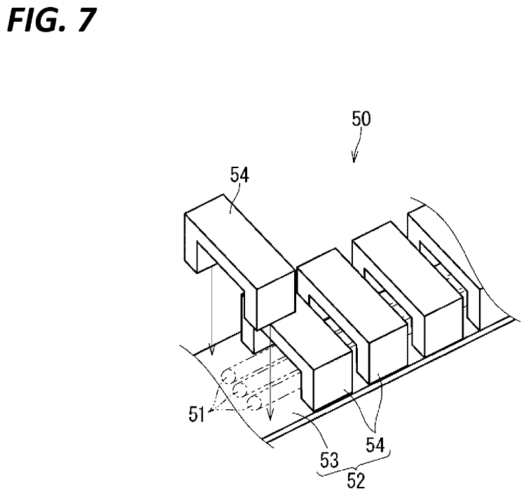

A wire harness routing apparatus according to a first embodiment will now be described. FIG. 1 is a perspective view depicting a wire harness routing apparatus 10 according to the first embodiment. FIG. 2 is a plan view depicting the wire harness routing apparatus 10 in a state where a slider 40 is at a first position P1. FIG. 3 is a plan view depicting the wire harness routing apparatus 10 in a state where the slider 40 is at a second position P2. Note that in FIGS. 2 and 3, a first rail member 21 and a lid 66 of an excess length accommodating portion 60 are omitted. FIG. 4 is a cross-sectional view depicting the wire harness routing apparatus 10. FIG. 4 is a cross-sectional view of the wire harness routing apparatus 10 taken at the position of a line IV-IV in FIG. 3. FIG. 5 is an exploded view depicting the wire harness routing apparatus 10. In FIG. 5, the parts drawn using chain double-dashed lines indicate parts that are changed when the number of circuits of a wire harness 50 is greater than the configuration drawn using solid lines. FIG. 6 is a perspective view depicting a first rail member 21. FIG. 7 is a perspective view depicting the wire harness 50.

Arrows X, Y, and Z are marked in FIG. 1. The arrows X, Y, and Z in FIG. 2 to FIG. 5 correspond to the arrows X, Y, and Z in FIG. 1. In the following description, the direction along the arrow X may be referred to as the “X direction” or the “left-right direction”, the orientation of the arrow X may be referred to as “left”, and the opposite orientation to the arrow X may be referred to as “right”. In the same way, the direction along the arrow Y may be referred to as the “Y direction” or the “front-rear direction”, the orientation of the arrow Y may be referred to as “forward”, and the opposite orientation to the arrow X may be referred to as “rearward”. The direction along the arrow Z may be referred to as the “Z direction” or the “vertical direction”, the orientation of the arrow Z may be referred to as “upward”, and the opposite orientation to the direction of the arrow Z may be referred to as “downward”.

The wire harness routing apparatus 10 according to the present embodiment is an apparatus for routing a wire harness 50 that connects a first part and a second part that slide relative to each other in a vehicle (not illustrated), such as an automobile. An example where the combination of the first part and the second part is a vehicle body and a seat 80 will be described here. The combination of the first part and the second part may be parts aside from the vehicle body and the seat 80, and as another example may be the vehicle body and a sliding door.

The seat 80 is slidably supported on the floor of the vehicle body via seat rails 82. As one example, a lower portion of the seat 80 is fixed to a seat slider that moves along the seat rails 82. The seat rails 82 extend in the Y direction. The seat 80 can be moved back and forth in the Y direction. The seat 80 is provided with electrical equipment. There are no particular limitations on such electrical equipment, which as examples may be an electric reclining apparatus, a seat heater, a sensor for detecting whether a passenger is seated, and a sensor for detecting whether a seat belt has been fastened. This electrical equipment of the seat may include one type, or two or more types.

The wire harness 50 of the wire harness routing apparatus 10 connects the electrical equipment of the seat 80 to electrical devices in the vehicle body. There are no particular limitations on the electrical devices in the vehicle body, which as examples may be a battery and an electronic control unit (ECU). The wire harness routing apparatus 10 routes the wire harness 50 in conjunction with sliding movement of the seat 80. The wire harness routing apparatus 10 is disposed so as to be aligned with the seat rails 82. The overall configuration of the wire harness routing apparatus 10 will now be described.

### <Overall Configuration>

The wire harness routing apparatus 10 includes a guide portion 20, a slider 40, and the wire harness 50.

The guide portion 20 includes the first rail member 21, a second rail member 26, and spacers 34. The first rail member 21 and the second rail member 26 face each other. The spacers 34 position the first rail member 21 and the second rail member 26 to generate an accommodating space 30 between the first rail member 21 and the second rail member 26.

The slider 40 is supported by the guide portion 20. The slider 40 can move back and forth between a first position P1 and a second position P2. The first position P1 is the position of the slider 40 when the seat 80 is located at one end in the Y direction (here, the “rear end”) relative to the seat rails 82. The second position P2 is the position of the slider 40 when the seat 80 is located at the other end in the Y direction (here, the “front end”) relative to the seat rails 82.

The wire harness 50 includes a slider fixed portion 55 and a moving section 56. The slider fixed portion 55 is fixed to the slider 40 and moves in conjunction with movement of the slider 40. The moving section 56 is continuous with the slider fixed portion 55. The moving section 56 moves within the accommodating space 30 due to movement of the slider 40.

In the wire harness routing apparatus 10, the size of the accommodating space 30 is determined by the spacers 34. The size of the accommodating space 30 can therefore be changed by changing the spacers 34. By doing so, even if the number of circuits in the wire harness 50 changes, such change can be accommodated by changing the spacers 34 without changing the first rail member 21 and the second rail member 26.

The units of the wire harness routing apparatus 10 will now be described in more detail.

### (Guide Portion 20)

The guide portion 20 is disposed between the pair of seat rails 82. However, the guide portion 20 may be disposed outside the pair of seat rails 82. Here, the guide portion 20 is disposed closer to the seat rail 82 on the right than the center of the pair of seat rails 82. However, the guide portion 20 may be disposed closer to the seat rail 82 on the left than the center of the pair of seat rails 82, or may be disposed in the center of the pair of seat rails 82.

The first rail member 21 includes a first bottom portion 22 and at least one first protruding wall portion 23. Each first protruding wall portion 23 protrudes from the first bottom portion 22 toward the second rail member 26. The second rail member 26 includes a second bottom portion 27 and at least one second protruding wall portion 28. The second bottom portion 27 faces the first bottom portion 22. Each second protruding wall portion 28 protrudes from the second bottom portion 27 toward the first rail member 21. The accommodating space 30 is a space surrounded by the first bottom portion 22, the at least one first protruding wall portion 23, the second bottom portion 27, and the at least one second protruding wall portion 28.

In the illustrated example, the first rail member 21 includes two first protruding wall portions 23. The two first protruding wall portions 23 are provided at an interval in the X direction (the left-right direction). Likewise, the second rail member 26 includes two second protruding wall portions 28. The two second protruding wall portions 28 are provided at an interval in the X direction. As depicted in FIG. 4, the two first protruding wall portions 23 and the two second protruding wall portions 28 face each other (as facing pairs). The accommodating space 30 is a space surrounded by the first bottom portion 22, the two first protruding wall portions 23, the second bottom portion 27, and the two second protruding wall portions 28.

In this example, the two first protruding wall portions 23 protrude by respectively different dimensions from the first bottom portion 22. One of the two first protruding wall portions 23 is a first long protruding wall portion 23A, and the other is a first short protruding wall portion 23B. The two second protruding wall portions 28 also protrude by respectively different dimensions from the second bottom portion 27. One of the two second protruding wall portions 28 is a second long protruding wall portion 28A, and the other is a second short protruding wall portion 28B. The first long protruding wall portion 23A and the second short protruding wall portion 28B face each other. The first short protruding wall portion 23B and the second long protruding wall portion 28A face each other.

Here, the first rail member 21 and the second rail member 26 are aligned along the Z direction (the vertical direction). The second rail member 26 is disposed so as to be positioned vertically below the first rail member 21. The spacers 34 separate the first rail member 21 and the second rail member 26 in the direction in which the members are aligned in parallel (here, the vertical direction).

The first rail member 21 and the second rail member 26 are fixed by bolts 35 at the positions of the spacers 34. The first protruding wall portions 23 are provided in an intermediate portion in the width direction (the X direction) of the first bottom portion 22. Fixing portions are provided at an edge portion of the first bottom portion 22 which is further outward than the first protruding wall portions 23. In the illustrated example, through-holes 24 through which the bolts 35 are inserted are formed as the fixing portions 24. The second protruding wall portions 28 are provided in an intermediate portion in the width direction of the second bottom portion 27. Fixing portions are provided at an edge portion of the second bottom portion 27 which is further outward than the second protruding wall portions 28. Here, through-holes 29 through which the bolt 35 are inserted are formed as the fixing portions 29. The through-holes 24 and 29 are formed on both sides of the accommodating space 30 in the X direction.

The spacers 34 may be formed in a tube shape that allows the bolts 35 to be inserted therein. In this case, the first rail member 21 and the second rail member 26 may be fixed using the bolts 35 and the nuts 36. In the example depicted in FIG. 5, the nuts 36 are fastened to the ends of the bolts 35 that have passed through the through-holes 24 in the first rail member 21, the spacers 34, and the through-holes 29 in the second rail member 26.

The spacers 34 may be threaded spacers. Such threaded spacers may be double male-threaded spacers. In this case, the two male threads of each double male-threaded spacer are inserted through a through-hole 24 in the first rail member 21 and a through-hole 29 of the second rail member 26, respectively, and then nuts 36 are fastened to the ends of these two male threads. However, the threaded spacers may be double female-threaded spacers. In this case, the ends of two bolts that have been respectively inserted through a through-hole 24 in the first rail member 21 and a through-hole 29 in the second rail member 26 are fastened to the two female threads of the double female-threaded spacer. The threaded spacer may also be a spacer with male and female threads. In this case, the male thread of the male-female-threaded spacer passes through one out of a through-hole 24 in the first rail member 21 and a through-hole 29 in the second rail member 26 and a nut 36 is then fastened to the end of this male thread. The end of a bolt that has been inserted through the other out of a through-hole 24 in the first rail member 21 and a through-hole 29 in the second rail member 26 is fastened to the female thread of the male-female threaded spacer.

The bolts 35 or nuts 36 may be integrated with the first rail member 21 or the second rail member 26 by welding or the like. In this case, such bolts or nuts can be regarded as fixing portions provided on the first rail member 21 or the second rail member 26 in place of the through-holes 24 and 29.

A gap between the first short protruding wall portion 23B and the second long protruding wall portion 28A is defined as an opening 31. A gap between the second short protruding wall portion 28B and the first long protruding wall portion 23A is defined as an opening 32. The wire harness 50 passes through at least one of these openings 31 and 32. In the illustrated example, the wire harness 50 passes through only one of the openings, the opening 31, and does not pass through the other opening 32. When the wire harness 50 moves together with the slider 40, part of the wire harness 50 moves along the opening 31.

The opening 31 is kept open to enable the wire harness 50 to move. Since the second long protruding wall portion 28A is positioned lower than the first short protruding wall portion 23B, the position of the opening 31 in the vertical direction is closer to the first bottom portion 22 than a center between the first bottom portion 22 and the second bottom portion 27. This means that even if a rod-shaped member, such as an umbrella or a walking stick, is inserted from above between the first bottom portion 22 and the second bottom portion 27, the member comes into contact with the second long protruding wall portion 28A and is unlikely to reach the openings 31 and 32. The position of the opening 31 is higher than the position of the opening 32 in the vertical direction.

Since the wire harness 50 does not pass through the opening 32, the opening 32 may be covered. The guide portion 20 may include a cover member that covers the opening 32. As one example, a plate member that is longer than the opening 32 in the vertical direction may extend along the opening 32.

In this example, bolt fixing portions that use the through-holes 24 and 29 are provided at a total of three or more locations to the outside of the opening 32, that is, at both ends in the length direction and at least one location in between. In the illustrated example, five bolt fixing portions are provided between both ends in the length direction. Accordingly, a total of seven bolt fixing portions are provided to the outside of the opening 32. To the outside of the opening 31, bolts are fixed at two locations at both ends in the length direction, but no bolt fixing portions are provided between the two ends in the length direction. Note that since the first rail member 21 and the second rail member 26 have the same shape, the through-holes 24 and 29 are formed outside the opening 31 at the same positions as outside the opening 32. Outside the opening 31, bolts 35 are not passed through the five through-holes 24 and 29 between both ends in the length direction. That is, outside the opening 31, there are through-holes 24 and 29 that are not fixed with bolts.

In this example, the opening 31 is continuous to end edges in the length direction of the guide portion 20. To prevent the slider 40 from coming off from the end edges in the length direction of the guide portion 20, stoppers 34B are provided on the spacers 34. The stoppers 34B are positioned at the ends of the direction in which the slider 40 moves and restrict movement of the slider 40.

In this example, spacers 34A, which are some out of the spacers 34, do not serve as the stoppers, and other spacers 34B out of the spacers 34 serve as the stoppers. In this example, among the spacers 34, the spacers 34A on the opening 32-side do not serve as a stopper. Out of the plurality of spacers 34, the spacers 34B on the side where the opening 31 is located also serve as stoppers. The stoppers 34B are located outside the opening 31 at ends in the length direction of the guide portion 20.

As one example, the spacers 34B that also serve as stoppers may be thicker than the spacers 34A that do not serve as stoppers. The spacers 34A are shaped in a cylindrical shape, and the spacers 34B are shaped as square tubes. The spacers 34B may be formed by attaching square tubular parts to the circumferences of spacers in a cylindrical shape like the spacers 34A.

An elastic member, such as rubber, or a flexible member, such as nonwoven fabric, may be provided on parts of the stoppers 34B that come into contact with the slider 40. By doing so, a shock absorbing effect or a sound deadening effect is obtained when the stoppers 34B come into contact with the slider 40.

The first rail member 21 and the second rail member 26 have the same shape. The posture of the second rail member 26 is produced by rotating the posture of the first rail member 21 by 180 degrees around an axis along the length direction. The first rail member 21 has a shape where a first cross-sectional shape is continuous in the length direction. This first cross-sectional shape is the cross-sectional shape of the first rail member 21 depicted in FIG. 4. Note that the expression “a shape where the first cross-sectional shape is continuous in the length direction” here refers to the shape of a main body of the first rail member 21 and excludes fixing portions, such as the through-holes 24. The same also applies to the cross-sectional shape of the second rail member described below. The second rail member 26 has a shape where a second cross-sectional shape is continuous in the length direction. The second cross-sectional shape is the cross-sectional shape of the second rail member 26 depicted in FIG. 4. As depicted in FIG. 4, the first cross-sectional shape and the second cross-sectional shape are the same. Members are produced by cutting an elongated base material, which has been formed to have the first cross-sectional shape by extrusion molding of metal or resin, to a predetermined length and the through-holes 24 and 29 are then formed in such cut members to form the first rail member 21 and the second rail member 26.

### (Slider 40)

The slider 40 moves together with the seat 80. The slider 40 may be fixed to the seat 80. The slider 40 is provided so as to move along the opening 31 on the left side (the seat rail 82 side that is further from the guide portion 20 out of the pair of seat rails 82) relative to the guide portion 20. However, the slider 40 may be provided so as to move along the opening 32 on the right side (the seat rail 82 side that is closer to the guide portion 20 out of the pair of seat rails 82) or along the openings 31 and 32 on both sides, relative to the guide portion 20.

In this example, the slider 40 includes a first end portion 41 and a second end portion 42. The first end portion 41 is positioned in the accommodating space 30. The second end portion 42 is positioned outside the guide portion 20. Part of the slider 40 between the first end portion 41 and the second end portion 42 extends between the pair of the first protruding wall portion 23 and the second protruding wall portion 28. In this example, the slider 40 extends from the first end portion 41 through the opening 31 between the first short protruding wall portion 23B and the second long protruding wall portion 28A toward the second end portion 42. The part of the slider 40 between the first end portion 41 and the second end portion 42 that passes through the opening 31 is an inserted portion 43. The second end portion 42 of the slider 40 extends in the up-down direction outside the outer edge of the first rail member 21 in the width direction (X direction) of the first rail member 21.

The slider 40 is movably supported on the first protruding wall portions 23 or the second protruding wall portions 28. In this example, the slider 40 is formed with fitting recesses 44. These fitting recesses 44 are formed above and below the inserted portion 43. A first protruding wall portion 23 fits into the fitting recess 44 above the inserted portion 43. A second protruding wall portion 28 fits into the fitting recess 44 below the inserted portion 43.

### (Wire Harness 50)

The wire harness 50 includes a plurality of electric wires 51 and a protective member 52. The protective member 52 keeps the plurality of electric wires 51 in a flattened arrangement in the moving section 56. The spacers 34 separate the first rail member 21 and the second rail member 26 in the length direction of a cross section of the flattened wire harness 50.

Here, the protective member 52 keeps the plurality of electric wires 51 aligned in the Z direction. The protective member 52 includes a base member 53 in the form of an elongated strip and a plurality of cover members 54. The base member 53 is bendable in the thickness direction thereof. Each cover member 54 is formed in a gutter-like shape with a bottom wall and a pair of side walls. The cover members 54 have flattened shapes. In this example, the bottom wall of each cover member 54 is longer than the side walls. The plurality of cover members 54 are attached to one main surface of the base member 53 so as to be aligned in the length direction of the base member 53. When the base member 53 is not bent in the thickness direction, adjacent cover members 54 may contact each other or may be separated. By attaching the cover members 54 to the base member 53, the base member 53 is capable of bending with the main surface that is opposite to the main surface to which the cover members 54 are attached facing inward, but bending with the main surface to which the cover members 54 are attached facing inward is restricted.

At least a portion of the part of the wire harness 50 that extends along the slider 40 is fixed to the slider 40 to form a slider fixed portion 55. In this example, the part of the wire harness 50 that extends along the slider 40 from the first end portion 41 to the second end portion 42 of the slider 40 is the slider fixed portion 55. There are no particular limitations on how the wire harness 50 and the slider 40 are fixed, and the method to be used can be set as appropriate, for example adhesive tape, adhesive, or clamping.

In the same way as at the part where the protective member 52 is provided, the plurality of electric wires 51 are aligned in the Z direction at the position of the first end portion 41 of the slider fixed portion 55. The plurality of electric wires 51 are aligned in the Y direction at the position of the second end portion 42 out of the slider fixed portion 55. Accordingly, the direction in which the plurality of electric wires 51 are aligned at the slider fixed portion 55 changes. Here, the plurality of electric wires 51 are aligned in the Y direction at the position of the inserted portion 43 in the slider fixed portion 55. Accordingly, in this example, the direction in which the plurality of electric wires 51 are aligned changes between the position of the first end portion 41 and the position of the inserted portion 43. Note that the plurality of electric wires 51 do not have to be aligned in a flattened arrangement in the inserted portion 43 or the position of the second end portion 42. The plurality of electric wires 51 may be bundled into a round cross-sectional shape at in the inserted portion 43 and at the position of the second end portion 42.

An end portion of the wire harness 50 that is closer to the electrical equipment of the seat 80 than the slider fixed portion 55 extends upward from the slider 40. The protective member 52 is not provided at this part. The moving section 56 is provided at the part of the wire harness 50 that is closer to the electrical equipment of the vehicle body than the slider fixed portion 55.

Here, the moving section 56 is a section where the length accommodated in the accommodating space 30 changes in keeping with the position of the slider 40 which moves back and forth between the first position P1 and the second position P2. Here, an opening in the accommodating space 30 is provided at both ends in the length direction of the guide portion 20. The wire harness 50 extends outside the guide portion 20 through one of these openings. As the slider 40 moves, the moving section 56 of the wire harness 50 moves in and out with respect to the guide portion 20 through this opening in an end portion of the guide portion 20. As depicted in FIG. 2, the length of the moving section 56 accommodated in the accommodating space 30 is longest when the slider 40 is at the first position P1. As depicted in FIG. 3, the length of the moving section 56 accommodated in the accommodating space 30 is shortest when the slider 40 is at the second position P2. When the slider 40 is at the second position P2, the length of the moving section 56 located outside the guide portion 20 is the longest.

Out of the moving section 56, a section that is accommodated in the accommodating space 30 when the slider 40 is at the first position P1 but is positioned outside the guide portion 20 when the slider 40 is at the second position P2 is referred to as the “excess length section 57”. As the slider 40 moves from the first position P1 toward the second position P2, the length of the excess length section 57 that is positioned outside the guide portion 20 increases. In this example, the wire harness routing apparatus 10 further includes the excess length accommodating portion 60. The part of the excess length section 57 that is positioned outside the guide portion 20 is accommodated in this excess length accommodating portion 60.

### (Excess Length Accommodating Portion 60)

The excess length accommodating portion 60 is disposed at the front end of the guide portion 20. However, the excess length accommodating portion 60 may be disposed at the rear end of the guide portion 20. The excess length accommodating portion 60 includes a main body 61 and a lid 66. The main body 61 and the lid 66 may be injection molded products made of electrically insulating synthetic resin, for example.

The main body 61 includes a bottom wall 62 and a peripheral wall 63. The bottom wall 62 is formed in a circular shape when viewed from above. The center of the bottom wall 62 is positioned on the slider 40-side of the accommodating space 30 (in this example, the left side). However, the center of the bottom wall 62 may be positioned on the non-slider 40-side of the accommodating space 30 (here, the right side). The peripheral wall 63 protrudes from an outer edge of the bottom wall 62 above on one main surface. An opening 64 is formed in the peripheral wall 63. The opening 64 is located in front of the end opening in the guide portion 20. The excess length section 57 that extends from the end opening of the guide portion 20 is accommodated inside the peripheral wall 63 through the opening 64. The lid 66 covers an upper opening of the main body 61.

A lead-out portion 65 for leading the wire harness 50 from the excess length accommodating portion 60 onto or under the floor of the vehicle is formed near the center of the bottom wall 62. As one example, the lead-out portion 65 is formed in a tubular shape that is erected from a position near the center of the bottom wall 62. A through hole that passes through the bottom wall 62 in the up-down direction is formed further inward than the lead-out portion 65, and the wire harness 50 is led out through this through-hole to above or below the floor of the vehicle. The wire harness 50 is fixed to the lead-out portion 65. As one example, the lead-out portion 65 may be provided with a clamping portion that clamps and fixes the wire harness 50. A part of the wire harness 50 that is closer to the outer periphery than the part fixed to the lead-out portion 65 moves inside the excess length accommodating portion 60 as the slider 40 moves.

In more detail, as depicted in FIG. 3, the excess length accommodating portion 60 accommodates the excess length section 57 located outside the guide portion 20 when the slider 40 is at the second position P2 in a spiral shape with an axis along the length direction of a cross section of the flattened wire harness 50 as the center axis. As depicted in FIG. 2, the wire harness 50 inside the excess length accommodating portion 60 extends in a spiral shape even when the slider 40 is at the first position P1. When the slider 40 is at the first position P1 or the second position P2, the wire harness 50 enters or exits the excess length accommodating portion 60 by changing the size of the spiral (that is, the distance between the radially inward portion and a radially outward portion) with hardly any change to the number of turns in the spiral.

When the slider 40 moves from the first position P1 toward the second position P2, the length of the wire harness 50 in the main body 61 increases and the spiral deforms to become looser and larger. By doing so, the excess length section 57 is gradually accommodated in the excess length accommodating portion 60. When the slider 40 moves from the second position P2 toward the first position P1, the length of the wire harness 50 inside the main body 61 decreases, and the spiral deforms to become tighter and smaller. By doing so, the excess length section 57 is gradually pulled out from the excess length accommodating portion 60.

### <Effects>

According to the wire harness routing apparatus 10 configured as described above, the size of the accommodating space 30 in the guide portion 20 can be changed by changing the spacers 34. By doing so, it is possible to easily accommodate differences in the number of circuits in the wire harness 50 with a single pair of the first rail member 21 and the second rail member 26. Changing the spacers 34 is easier than changing the first rail member 21 and the second rail member 26. This means that the wire harness routing apparatus 10 can be easily applied to a plurality of types of wire harnesses 50 that have different numbers of circuits.

In more detail, in FIG. 5, the number of circuits in a wire harness 150 indicated by the two-dash chain line is greater than the number of circuits in the wire harness 50 indicated by the solid line. The wire harness 150 includes a larger number of electric wires 51 than the wire harness 50. A protective member 152 of the wire harness 150 is longer in the length direction of its flattened cross section than the protective member of the wire harness 50. When the wire harness 150 is used in place of the wire harness 50, the guide portion 20 can be changed to a suitable guide portion for the wire harness 150 by using spacers 134A and 134B in place of the spacers 34A and 34B in the guide portion 20. That is, the spacers 134A and 134B are longer than the spacers 34A and 34B. By doing so, the interval between the first rail member 21 and the second rail member 26 when the spacers 134A and 134B are provided becomes larger than the interval between the first rail member 21 and the second rail member 26 when the spacers 34A and 34B are provided, which means that the accommodating space 30 increases. These spacers 34A, 34B, 134A, and 134B are general-purpose components that are more readily available than the first rail member 21 and the second rail member 26. The spacers 34A, 34B, 134A, and 134B also have a simpler shape that is smaller and easier to form than the first rail member 21 and the second rail member 26. This means that it is easier to change the spacers 34A, 34B, 134A, and 134B than to change the first rail member 21 and the second rail member 26.

In FIG. 5, when the wire harness 150 is used in place of the wire harness 50, the bolts 35 are also replaced with bolts 135. However, in some cases such as where the spacers are female-threaded spacers, the bolts 35 may be used as is without being replaced. In other cases such as where the spacers are male-threaded spacers, the bolts 35 may be omitted. With this configuration, fewer parts are changed when changing between the wire harnesses 50 and 150.

The slider 40 is supported by the first protruding wall portion 23 or the second protruding wall portion 28, and the accommodating space 30 is a space surrounded by the first bottom portion 22, at least one first protruding wall portion 23, the second bottom portion 27, and at least one second protruding wall portion 28. By doing so, the slider 40 is supported by the protruding wall portions 23 and 28 and both sides of the moving section 56 can be covered by the protruding wall portions 23 and 28, which makes it easier for the slider 40 and the wire harness 50 to move smoothly relative to the guide portion 20.

The accommodating space 30 is a space surrounded by the first bottom portion 22, the two first protruding wall portions 23, the second bottom portion 27, and the two second protruding wall portions 28, and the part of the slider 40 between the first end portion 41 and the second end portion 42 extends between a pair of one first protruding wall portion 23 and one second protruding wall portion 28. By doing so, the protruding wall portions 23 and 28 can cover both sides of the slider 40 and the moving section 56 on the first bottom portion 22 side and the second bottom portion 27 side, respectively. In other words, the protruding wall portions 23 and 28 can cover both sides of the slider 40 and the moving section 56 above and below the openings 31 and 32. By doing so, it becomes easier for the slider 40 and the wire harness 50 to move smoothly relative to the guide portion 20.

A gap between the pair of one first protruding wall portion 23 and one second protruding wall portion 28 is set as the opening 31 through which the slider 40 passes. In this case, by using the second long protruding wall portion 28A as the protruding wall portion 28 below the opening 31, it is possible to suppress the intrusion of foreign matter located outside the guide portion 20 into the accommodating space 30 through the opening 31.

The first rail member 21 and the second rail member 26 have the same shape. By doing so, the first rail member 21 and the second rail member 26 can be produced by preparing a plurality of parts of a single type, which reduces the number of types of parts.

The first rail member 21 has a first cross-sectional shape that is continuous in the length direction and the second rail member 26 has a second cross-sectional shape that is continuous in the length direction, where the first cross-sectional shape and the second cross-sectional shape are the same. By doing so, it is possible to cut out predetermined lengths from an elongated extrusion-molded product to form the first rail member 21 and the second rail member 26. It is also easy to accommodate changes in the length of the first rail member 21 and the second rail member 26.

The stoppers 34B, which are positioned at ends of the slider 40 in the direction of movement, are provided on the spacers 34. Doing so eliminates the need to provide the stoppers 34B at positions that are separate from the spacers 34.

The spacers 34 separate the first rail member 21 and the second rail member 26 in the length direction of a cross section of the flattened wire harness 50. With this configuration, when the number of circuits increases, the moving section 56 will become larger in the length direction of the flattened cross sectional shape. This means that an increase in the thickness of the moving section 56 is suppressed even when the number of circuits in the wire harness 50 increases.

Here, when the slider 40 moves, the moving section 56 (the excess length section 57) of the wire harness 50 bends in the thickness direction. The thickness at the moving section 56 does not change even when the number of circuits in the wire harness 50 changes, which makes it unlikely for the ease with which the wire harness 50 can bend to change. This makes it easier to accommodate changes in the number of circuits in the wire harness 50 compared to a configuration where the ease with which the wire harness 50 can bend is likely to change.

In addition, the wire harness routing apparatus 10 further includes the excess length accommodating portion 60 that accommodates the excess length section 57 positioned outside the guide portion 20 when the slider 40 is at the second position P2, in a spiral shape with an axis along the length direction of a cross section of the flattened wire harness 50 as the center axis. When the number of circuits has increased, the excess length section 57 also becomes larger in the length direction of the flattened cross-sectional shape. By accommodating the excess length section 57 in the excess length accommodating portion 60 in a spiral shape with an axis along the length direction in a cross section of the flattened wire harness 50 as the center axis, increases in the diameter of the excess length section 57 accommodated in the spiral shape are suppressed, even when the number of circuits in the wire harness 50 increases.

### Appendix

Although a configuration where the first rail member 21 includes the first protruding wall portion 23 and the second rail member 26 includes the second protruding wall portion 28 has been described above, such configuration is not essential. As one example, the first rail member 21 does not need to include the first protruding wall portion 23. As another example, the second rail member 26 does not need to include the second protruding wall portion 28. Also, although the wire harness 50 has been described above as passing between a first protruding wall portion 23 and a second protruding wall portion 28, this is not essential. As other examples, the wire harness 50 may pass through a hole in the first bottom portion 22 of the first rail member 21 or a hole in the second bottom portion 27 of the second rail member 26.

Although a configuration where the first rail member 21 includes two first protruding wall portions 23 and the second rail member 26 includes two second protruding wall portions 28 has been described, this is not essential. As one example, the first rail member 21 may include one first protruding wall portion 23. As another example, the second rail member 26 may include one second protruding wall portion 28. In another example, the first short protruding wall portion 23B of the first rail member 21 and the second short protruding wall portion 28B of the second rail member 26 may be omitted. In another example, the first rail member 21 may be provided with a protruding wall portion aside from the two first protruding wall portions 23. Likewise, the second rail member 26 may be provided with a protruding wall portion aside from the two second protruding wall portions 28.

Although a configuration where the first rail member 21 includes the first long protruding wall portion 23A and the first short protruding wall portion 23B, and the second rail member 26 includes the second long protruding wall portion 28A and the second short protruding wall portion 28B has been described thus far, this is not essential. As one example, the protruding dimensions of the two first protruding wall portions 23 of the first rail member 21 may be the same. As another example, the protruding dimensions of the two second protruding wall portions 28 of the second rail member 26 may be the same. Although a configuration where the first long protruding wall portion 23 A and the second short protruding wall portion 28B face each other and the second long protruding wall portion 28A and the first short protruding wall portion 23B face each other has been described, this is not essential. The first long protruding wall portion 23A and the second long protruding wall portion 28A may face each other, and the first short protruding wall portion 23B and the second short protruding wall portion 28B may face each other.

Although the first rail member 21 and the second rail member 26 have been described above as having the same shape, this is not essential. The first rail member 21 and the second rail member 26 may have different shapes.

Although the first cross-sectional shape of the first rail member 21 and the second cross-sectional shape of the second rail member 26 have been described above as being the same, this is not essential. The first cross-sectional shape of the first rail member 21 and the second cross-sectional shape of the second rail member 26 may be different from each other.

Although the stoppers 34B have been described as being provided on the spacers 34, this is also not essential. As one example, the stoppers 34B may be provided at positions that are separate from the spacers 34.

Although the cross-sectional shape of the wire harness 50 has been described thus far as being a flattened shape, this is also not essential. The cross-sectional shape of the wire harness 50 may be circular or square, for example. Although the spacers 34 have been described as separating the first rail member 21 and the second rail member 26 in the length direction of a cross-section of a flattened wire harness 50, this is not essential. The spacers 34 may separate the first rail member 21 and the second rail member 26 in the direction of a short dimension in the cross section of a flattened wire harness 50.

In addition, although the wire harness routing apparatus 10 has been described above as including the excess length accommodating portion 60, this is not an essential component. The excess length accommodating portion 60 may be omitted. In addition, although the wire harness routing apparatus 10 has been described above as including the excess length accommodating portion 60 that accommodates the wire harness 50 in a spiral shape, this is not essential. As another example, the excess length accommodating portion 60 may accommodate the wire harness 50 in a U-shape or the like.

The configurations described above in the embodiments and modifications can be combined as appropriate so long as doing so is not technically inconsistent.

### LIST OF REFERENCE NUMERALS

10 Wire harness routing apparatus
20 Guide portion
21 First rail member
22 First bottom portion
23 First protruding wall portion
23A First long protruding wall portion (or “first protruding wall portion”)
23B First short protruding wall portion (first protruding wall portion)
24 Through-hole
26 Second rail member
27 Second bottom portion
28 Second protruding wall portion
28A Second long protruding wall portion (second protruding wall portion)
28B Second short protruding wall portion (second protruding wall portion)
29 Through-hole
30 Accommodating space
31, 32 Opening
34, 34A, 134A, 134B Spacer
34B Stopper (spacer)
35, 135 Bolt
36 Nut
40 Slider
41 First end portion
42 Second end portion
43 Inserted portion
44 Fitting recess
50, 150 Wire harness
51 Electric wire
52, 152 Protective member
53 Base member
54 Cover member
55 Slider fixed portion
56 Moving section
57 Excess length section
60 Excess length accommodating portion
61 Main body
62 Bottom wall
63 Peripheral wall
64 Opening
65 Lead-out portion
66 Lid
80 Seat
82 Seat rail
P1 First position
P2 Second position

1. A wire harness routing apparatus comprising:
a guide portion including a first rail member and a second rail member that face each other and spacers that position the first rail member and the second rail member so that an accommodating space is produced between the first rail member and the second rail member;
a slider supported by the guide portion so as to be capable of reciprocally moving between a first position and a second position; and
a wire harness including a slider fixed portion that is fixed to the slider and moves in conjunction with movement of the slider and a moving section that is continuous with the slider fixed portion and moves inside the accommodating space as the slider moves.

2. The wire harness routing apparatus according to claim 1,
wherein the first rail member includes a first bottom portion and at least one first protruding wall portion that protrudes from the first bottom portion toward the second rail member,
the second rail member includes a second bottom portion that faces the first bottom portion and at least one second protruding wall portion that protrudes from the second bottom portion toward the first rail member,
the slider is supported by the first protruding wall portion or the second protruding wall portion, and
the accommodating space is a space surrounded by the first bottom portion, the at least one first protruding wall portion, the second bottom portion, and the at least one second protruding wall portion.

3. The wire harness routing apparatus according to claim 2,
wherein the first rail member includes two first protruding wall portions,
the second rail member includes two second protruding wall portions that face the two first protruding wall portions,
the accommodating space is a space surrounded by the first bottom portion, the two first protruding wall portions, the second bottom portion, and the two second protruding wall portions,
the slider includes a first end portion located in the accommodating space and a second end portion located outside the guide portion, and
a part of the slider between the first end portion and the second end portion extends between a pair of one first protruding wall portion and one second protruding wall portion.

4. The wire harness routing apparatus according to claim 3,
wherein the two first protruding wall portions are a first long protruding wall portion and a first short protruding wall portion that have different protruding dimensions from the first bottom portion,
the two second protruding wall portions are a second long protruding wall portion and a second short protruding wall portion that have different protruding dimensions from the second bottom portion,
the first long protruding wall portion and the second short protruding wall portion face each other and the first short protruding wall portion and the second long protruding wall portion face each other,
the second rail member is disposed so as to be positioned vertically below the first rail member, and
the slider extends from the first end portion toward the second end portion while passing between the first short protruding wall portion and the second long protruding wall portion.

5. The wire harness routing apparatus according to claim 1,
wherein the first rail member and the second rail member have the same shape.

6. The wire harness routing apparatus according to claim 5,
wherein the first rail member is shaped so that a first cross-sectional shape is continuous in a length direction,
the second rail member is shaped so that a second cross-sectional shape is continuous in a length direction, and
the first cross-sectional shape and the second cross-sectional shape are the same.

7. The wire harness routing apparatus according to claim 1,
wherein stoppers are provided on the spacers at end portions in a direction of movement of the slider.

8. The wire harness routing apparatus according to claim 1,
wherein the wire harness includes a plurality of electric wires and a protective member that keeps the plurality of electric wires in a flattened arrangement in the moving section, and
the spacers separate the first rail member and the second rail member in a length direction of a cross section of the flattened wire harness.

9. The wire harness routing apparatus according to claim 8,
wherein the moving section is a section whose length accommodated in the accommodating space changes in keeping with a position of the slider that moves reciprocally between the first position and the second position,
a section out of the moving section that is accommodated in the accommodating space when the slider is at the first position and is positioned outside the guide portion when the slider is at the second position is defined as an excess length section, and
the wire harness routing apparatus further comprises an excess length accommodating portion that accommodates, when the slider is at the second position, the excess length section positioned outside the guide portion in a spiral shape that has an axis along the length direction as a center axis.
